(19) United States
(12) Patent Application Publication
(10) Pub. No.: US 2025/0285063 A1
(43) Pub. Date: Sep. 11, 2025

(54) Ontology System Data Validation for Monitoring Communication System Data Handling Facilities

(71) Applicant: T-Mobile Innovations LLC, Overland Park, KS (US)

(72) Inventors: Manjith BAHULEYAN, Bothell, WA (US); John COSTER, Seattle, WA (US); Abhishek Paresh JAJAL, Bellevue, WA (US); Sean Michael Clarke SEEMANN, Seattle, WA (US); Sundeepkumar SINGH, Guelph (CA)

(21) Appl. No.: 18/596,365

(22) Filed: Mar. 5, 2024

(51) Int. Cl. G06Q 10/0639

(52) U.S. Cl. CPC G06Q 10/06393

(57) ABSTRACT

In some examples, a method for managing an ontology of a data handling facility of a communication system includes receiving data points from a node of the data handling facility, the data points indicating the node as a reporting node. The method also includes performing name-based data validation of the data points. The method also includes responsive to the data points passing the name-based data validation, recording the data points in a data store. The method also includes determining a performance metric based on the data points. The method also includes comparing the performance metric to an expected metric. The method also includes responsive to the performance metric having a difference from the expected metric that exceeds a standard deviation, performing remedial actions regarding the data handling facility.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication systems, including systems incorporating telecommunications and data networks, rely on scalable data handling infrastructure to support the demand for high-speed data transfer and low-latency communication across the communication system. Particularly, data handling facilities, such as data centers (e.g., mini-data centers, mobile switching offices, etc.), form the backbone of communication systems by providing centralized storage, processing, and management of data communicated thereacross. The demand for agile, efficient, and scalable data handling facilities has increased with the growing volume and complexity of networked applications and services.

### SUMMARY

In some examples, a method for managing an ontology of a data handling facility of a communication system includes receiving data points from a node of the data handling facility, the data points indicating the node as a reporting node. The method also includes performing name-based data validation of the data points. The method also includes responsive to the data points passing the name-based data validation, recording the data points in a data store. The method also includes determining a performance metric based on the data points. The method also includes comparing the performance metric to an expected metric. The method also includes responsive to the performance metric having a difference from the expected metric that exceeds a standard deviation, performing remedial actions regarding the data handling facility.

In some examples, a method for managing an ontology of a data handling facility of a communication system includes receiving data points from a node of the data handling facility, the data points indicating the node as a reporting node. The method also includes performing name-based data validation of the data points. The method also includes responsive to the data points passing the name-based data validation, recording the data points in a data store. The method also includes determining data integrity of the data handling facility by determining a ratio of recorded data points over a specified period of time to a number of expected data points over the specified period of time.

In some examples, a method for managing an ontology of a data handling facility of a communication system includes receiving data points from a node of the data handling facility, the data points indicating the node as a reporting node. The method also includes performing name-based data validation of the data points. The method also includes responsive to the data points passing the name-based data validation, recording the data points in a data store. The method also includes cross-referencing an inventory management system to perform an inventory-based data validation of the data points.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to an example of the disclosure.

FIG. 2 is a schematic diagram of a data handling facility according to an example of the disclosure.

FIG. 3 is flow chart of a method for managing an ontology of a data handling facility of a communication system according to an example of the disclosure.

FIG. 4 is flow chart of another method for managing an ontology of a data handling facility of a communication system according to an example of the disclosure.

FIG. 5A is a block diagram of another communication system according to an example of the disclosure.

FIG. 5B is a block diagram of a core network of the communication system of FIG. 5A according to an example of the disclosure.

FIG. 6 is a block diagram of a computer system according to an example of the disclosure.

### DETAILED DESCRIPTION

It should be understood at the outset that although illustrative implementations of one or more examples are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Modern communication networks transport communication content, including voice communication, in the form of digitally encoded data. As described above, data handling facilities of communication systems form the backbone of the communication system such that data (e.g., in the form of network traffic) may be communicated across the communication system as desired by a plurality of end users of the communication system. Particularly, data handling facilities house the telecommunication hardware comprising computer systems in the form of servers, network switches, routers, datastores, and other equipment used to route data across the communication system or which otherwise facilitates the management of the communication system. As an example, telecommunication hardware may comprise modular components, including server racks, that can be easily added or removed to adjust to changing requirements. In addition, data handling facilities may utilize high-density computing equipment, such as blade servers and optimized server designs, to maximize processing power within a given physical footprint. Further, efficient space utilization is achieved through techniques like virtualization and containerization.

Data handling facilities furnish the telecommunication hardware with different resources so that the hardware may operate as intended by an operator or network provider of the communication system. For example, data handling facilities include physical support structures (e.g., physical infrastructure) that provides the telecommunication hardware with the physical space required for properly housing said telecommunication hardware. In addition, data handling facilities include power systems for providing the telecommunication hardware contained in the data handling facility with the electrical power required by the telecommunication hardware for its normal operation. Further, data handling facilities include cooling systems for maintaining the telecommunication hardware within its respective normal operating temperature ranges in spite of the often-substantial heat generated by the telecommunication hardware during normal operation. Data handling facilities may include other or support or auxiliary systems as well, such as systems for providing physical security for the telecommunication hardware, preventing or suppressing fires within the data handling facility, and the scope of these support or auxiliary systems is not limited herein.

The available space, power, and cooling capacities of data handling facilities may be documented or estimated in different ways. For example, the space, power, cooling capacities of a given data handling facility may be captured in construction or engineering drawings created during initial construction of the data handling facility. However, engineering and similar drawings are not always a reliable indicator of the current capacities of the data handling facility making it difficult to determine or monitor the current space, power, and/or cooling capacities of data handling facilities from available resources like engineering drawings.

Although enterprises operating data handling facilities in support of an ongoing mission conducted by the enterprise (e.g., the managing of a telecommunication network, the managing of an industrial operation) may possess at some level information regarding the space, power, and cooling resources of those data handling facilities, conventionally enterprises have failed to capture and integrate said information to facilitate a more rational management of the space, power, and cooling resources of the data handling facilities. In other words, while the enterprise may possess various threads of information regarding the data handling facilities that it operates, conventionally enterprises have failed to weave together these separate threads in a manner that permits the enterprise to visualize the current state of its data handling facilities as well as what would most likely occur to those data handling facilities (and to the enterprise's ability to conduct its given mission) should particular and defined hypothetical scenarios were to take place. Instead, data must be laboriously aggregated from disconnected sources and manually analyzed in order to forecast impacts to the data handling facility (or to the larger communication system comprising the data handling facility) to changes in the operation of the data handling facility.

To at least partially address this challenge, the enterprises may implement systems, methods, or other techniques for managing ontologies of data handling facilities of communication systems. At least one example of such systems, methods, or other technique is taught in U.S. Patent Application No. ______, filed on ______ and entitled “Ontology Systems for Monitoring Data Handling Facilities of a Communication System,” which is incorporated herein by reference in its entirety.

As used herein, the term “ontology” refers to a state of a data handling facility at a given point time expressed in the form of a topological data structure that may be graphical in form but can take on other forms such as a database and the like. The ontologies may be formed automatically (or at least semi-automatically) based on time-series data obtained from a plurality of electrical power monitors connected between the electrically powered components of the data handling facility. In this manner, the power monitors may capture the flow of electrical power through the data handling facility over time, including the flow of electrical power through components of the power and/or other (such as cooling) systems thereof along with, in some examples, the telecommunication hardware of the data handling facility.

While such systems, methods, or other techniques for managing ontologies of data handling facilities of communication systems may enable a more intelligent and informed view of the ontological data, they may still face various challenges. Particularly, challenges may exist in understanding the broader context of the data, validating the data, and determining whether or not the data is trustworthy or a useful representation of operational characteristics of the data handling facilities of communication systems. Particularly, the systems, methods, or other techniques for managing ontologies of data handling facilities of communication systems (subsequently referred to herein as an ontological tool) may indicate a 100% uptime of devices in the data handling facilities. However, the missing information may be that the 100% uptime is for only 20% of the nodes monitored in a data handling facility because the remaining 80% of nodes are not reporting data. Thus, while data is present, the data may be unreliable, or have a low integrity value.

Accordingly, examples of this description provide for validation of data resulting from ontological tools. In some examples, the remedial actions are taken responsive to the validation. The validation may take one or more of various forms. For example, the validation may determine whether monitored nodes are active or inactive. The validation may also determine data integrity for the monitored nodes. The validation may also compare data integrity or other data resulting from monitoring of a first data handling facility to data integrity or other data resulting from monitoring of a second data handling facility. As used herein, data integrity is an indication of a volume of received data points to a volume of expected data points. For example, a data handling facility may include 10 nodes which may be monitored. Each node may be programmed, or expected, to provide a data point (e.g., a status update, a heartbeat signal, a measurement, or the like) at a particular interval. For example, each node of the 10 nodes may be programmed or expected to provide a data point to a central management or monitoring device (e.g., server) at 15 minute intervals. Thus, in this scenario, a 24 hour period of time, a particular node may be expected to provide 96 data points, and the data handling facility including the 10 nodes may be expected to provide 960 data points.

However, the central monitoring device may have received or recorded only 720of the 960 expected data points. In such an example, the data integrity for that data handling facility may be determined as 720/960, which equals 0.75, or about 75%. In some examples, different enterprises, or an enterprise for different data handling facilities, may establish thresholds of acceptable data integrity. For example, data integrity of 90%, 95%, or any other percentage may be deemed acceptable for all data handling facilities of the enterprise. In another example, the enterprise may establish a first threshold of acceptability for data integrity for a first data handling (or other) facility and establish a second threshold of acceptability for data integrity for a first data handling (or other) facility.

In some examples, the central monitoring device also determines whether a monitored node is active or inactive. For example, a node may be deemed active if the central monitoring device has received a data point from the monitored node within a programmed period of time. The programmed period of time may be, for example, a 24-hour period (either aligned with a calendar day, or a rolling 24-hour period). In other examples, the programmed period may be any other suitable amount of time, such as about 1 hour, about 6 hours, about 12 hours, about 48 hours, or the like. A node may be deemed inactive if the node is not active.

In some examples, the central monitoring device may perform other forms of data validation. For example, based on monitored behavior of multiple data handling facilities, a performance model may be generated by the central monitoring device automatically without human intervention, or with additional user input. The central monitoring device may compare the performance (e.g., data integrity or other monitored values) of a first data handling facility to that of a second data handling facility, the model, or the like. In some examples, the central monitoring device may compare data within a particular data handling facility. For example, alternating current (AC) power flowing into a conversion and distribution system may be monitored. Additionally, direct current (DC) power flowing into multiple network racks having power devices may be monitored, where each of the multiple network racks are powered from the same conversion and distribution system. Thus, a measure of the DC power (such as current flow) should approximately equal a measure of the AC power, accounting for conversion or other inherent losses. However, when a discrepancy greater than an acceptable threshold amount exists between the incoming and outgoing power measurements, the central monitoring device may determine that an error exists in the data, such as a reporting failure of one or more of the monitored nodes, a hardware failure of one or more of the monitored nodes, or the like.

In some examples, responsive to determining that an error exists, the central monitoring device may cause mitigation actions to be performed by, or on, one or more nodes. In an example, the central monitoring device generates and provides a notification to a technician or other user to instruct the user to perform the mitigating action. In other examples, the central monitoring device directly controls the node, or another device, to perform the mitigating action without human intervention or action. For example, the central monitoring device may issue a command that causes the node, or another device in communication with the node (such as a gateway through which the node communicates with a network to report data points) to power cycle. In another example, the central monitoring device may cause a breaker or other switch of the conversion and distribution system to toggle. In another example, the central monitoring device may cause a network connection of the node or another device in communication with the node to reset. In other examples, the central monitoring device may command or cause the node or another device in communication with the node to perform any action determined to have, or potentially have, a mitigating effect on an error associated with the node.

In some examples, the central monitoring device may cross-reference multiple databases, tools, or the like to perform the data validation. For example, a data handling facility may include multiple buildings, floors, rooms, or the like, each of which may include multiple rows or other arrangements of racks containing network elements. At least some of these racks may include one or more sensors, which may be referred to herein as nodes. For example, at least some racks may include powered components which receive power from a distribution, or distribution and conversion, system, as described above. The racks may include multiple power feeds to provide redundancy, such as a first feed and a second feed, or an A side and a B side feed. Respective current transducers (e.g., sensors, and referred to herein as nodes) may be coupled with each of the power feeds to provide power monitoring for a rack powered by the power feeds. Each node may have a standardized naming format. For example, each node may be assigned a globally unique identifier (GUID) by a manufacturer, vendor, or the like. However, the GUID may not be a particularly useful manner of referencing a node in a production environment. As such, the nodes may be given “friendly” names. The friendly name may include an identifier for the facility (such as common language location identifier (CLLI)), a device category (relay rack, power distribution unit, gateway, etc.), a room number identity, a row number identity, a position within the row identity, and a device in the rack (e.g., a current transducer on the B feed and the 4^{th} feed of the B feed lines). In some examples, the central monitoring device may perform further validation based on the friendly name of the nodes. For example, the central monitoring device may perform a regular expression check of the friendly name to determine whether the friendly name has a proper format.

In some examples, each data handling facility may have an associated inventory which may be maintained by an asset or inventory management system. For example, the asset management system may indicate that for data handling facility ABC, floor X, room Y, 23 powered racks are present. However, the central monitoring device may determine that data points are being received from some number of racks greater or lesser than the expected number of racks. This may indicate an error in the inventory management system or a data integrity issue, each warranting further analysis of data obtained from the data handling facility and/or the dispatch of a technician to further investigate the discrepancy.

In this way, a central monitoring device may perform multi-level data validation of data captured by an ontological tool. The data validation may increase confidence in the data captured by the ontological tool and provide insights

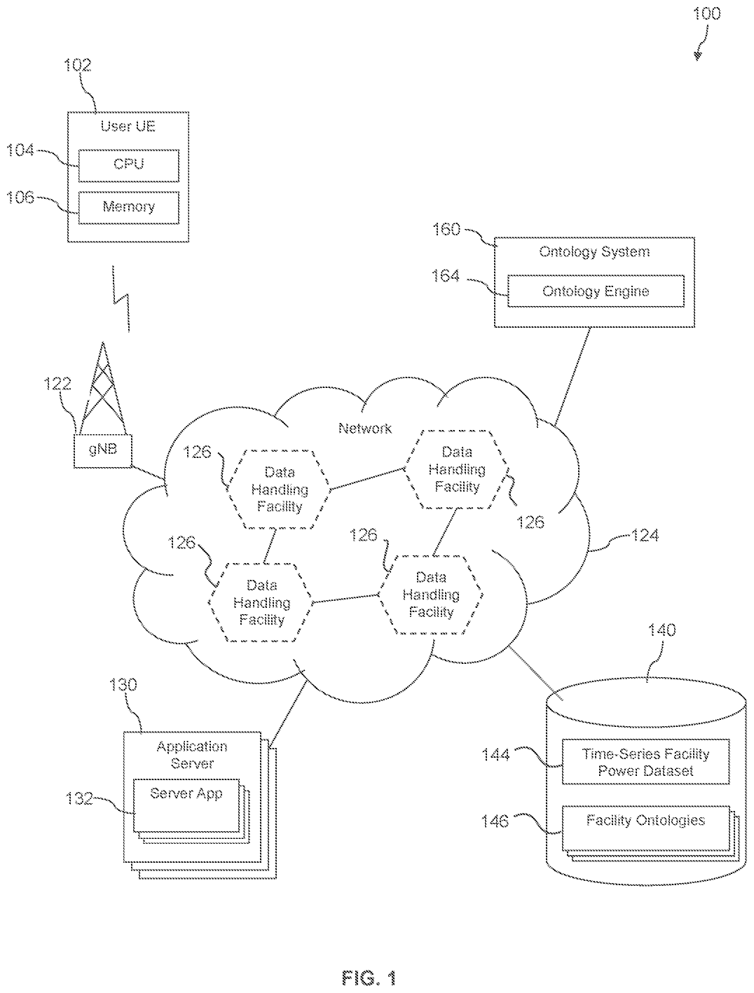

Turning to FIG. 1, a communication system 100 is described. In an example, the communication system 100 generally includes a user equipment (UE) 102, an access node 122, a network 124, an application server 130, a datastore 140, and an ontology system 160. In at least some examples, the ontology system 160 is implemented as one or more software applications executing on a computer system, a server, in a cloud computing environment, or the like. UE 102 may comprise, for example, a desktop computer, a workstation, a laptop computer, a tablet computer, a smartphone, a wearable computer, an Internet of things (IoT) device, and/or a notebook computer. UE 102 may be operated by a user or customer of the network 124 such as an enterprise, organization, or individual.

The access node 122 of communication system 100 may provide communication coupling the UE 102 to the network 124 according to a 5G protocol, for example 5G, 5G New Radio, or 5G LTE radio communication protocols. The access node 122 may provide communication coupling the UE 102 to the network 124 according to a long term evolution (LTE), a code division multiple access (CDMA), and/or a global system for mobile communication (GSM) radio communication protocol. The access node 122 may be referred to for some contexts as a gigabit Node B (gNB), an enhanced Node B (eNB), a cell site, or a cell tower. Additionally, while not shown, UE 102 may be communicatively coupled to the network 124 via a WiFi access point or another non-cellular radio device. Further, while a single access node 122 is illustrated in FIG. 1, the communication system 100 may comprise any number of access nodes 122.

Network 124 comprises a plurality of interconnected data handling facilities 126 that form or define the backbone of the network 124 (with access nodes 122 forming the skin of the network 124) and which direct network traffic (e.g., traffic generated by UE 102 and/or application server 130) across the network 124 to its intended destination. Data handling facilities 126 thus include the telecommunication hardware required for directing network traffic including network servers, routers, and switches, along with equipment necessary for supporting the telecommunication hardware such as a power system for supplying adequate power to the telecommunication hardware, a cooling system for cooling the telecommunication hardware such that it may remain within a desired operational temperature range, and other support or auxiliary systems.

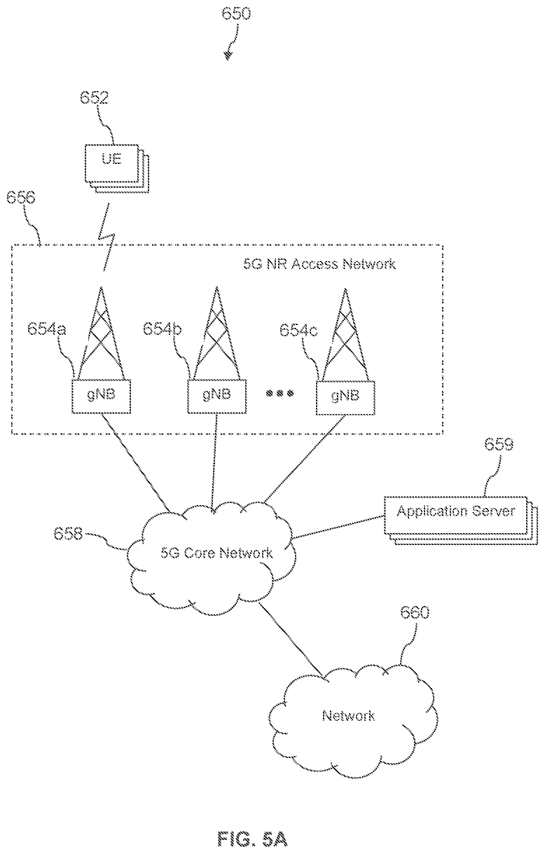

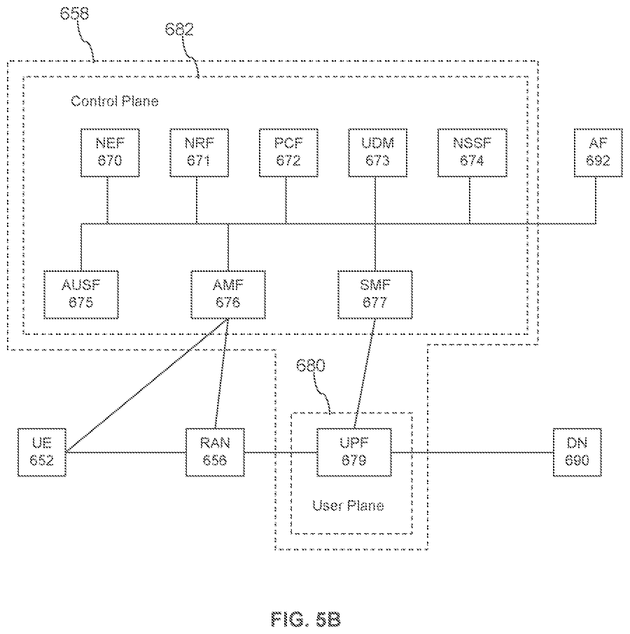

The network 124 of communication system 100 may comprise one or more public networks, one or more private networks, or a combination thereof. For example, network 124 may comprise a core network, such as a 5G core network. Further details of 5G networks are discussed below with reference to FIGS. 5A, 5B. While shown as communicatively coupled to the network 124, application server 130, datastore 140, and ontology system 160 may be considered part of network 124 and are illustrated as separate from network 124 in FIG. 1 to promote description their roles with respect to UE 102, as will be described further herein. Additionally, although in FIG. 1 the network 124 is shown as including only a single datastore 140 and application server 130, the network 124 may include varying numbers of datastores and servers.

UE 102 includes a processor or CPU 104 and a memory 106 in signal communication with the processor 104. UE 102 may access various resources of network 124 through the access node 122. For example, users of UE 102 may transmit information from UE 102 to the network 124 through the access node 122 and save the transmitted information on the network 124, such as on datastore 140. In addition, UE 102 may access at least some of the resources of the application server 130, where application server 130 may include one or more server applications 132. Server applications 132 may provide one or more services or features accessible by the user through UE 102.

The datastore 140 of communication system 100 includes one or more facility power datasets 144 (e.g., corresponding to the data handling facilities 126 of network 124), and one or more facility ontologies 146 (e.g., corresponding to the data handling facilities 126 of network 124).

Facility power datasets 144 comprise data of the flow of electrical power through the data handling facilities 126 over time. In some examples, facility power dataset 144 has a granularity sufficient to capture the flow of electrical power through the different electrically powered components of a given data handling facility 126. These electrically powered components may comprise components of a power system (e.g., a switchgear, a circuit breaker, a panel, a transformer, a rectifier) of the data handling facility 126, a cooling system (e.g., a fan or blower, an evaporator, a condenser, a chiller) of the data handling facility 126, and/or telecommunication hardware of the data handling facility such as, for example, network servers, routers, and switches. Facility power dataset 144 may be captured in real-time or near real-time by a plurality of electrical power meters or power sensors of the different data handling facilities 126 forming network 124, as will be discussed further herein.

The facility ontologies 146 of datastore 140 are generated by the ontology system 160 of communication system 100 and provide different ontologies for the data handling facilities 126 forming network 124. Particularly, facility ontologies organize or embed the facility power dataset 144 (and in some examples network traffic associated with the data handling facilities 126, as well) into a single, interrogable ontology data structure. The ontology data structure may take on different forms such as a tabular form, a graphical form, and the like.

Facility ontologies 146 may be multi-layered including an infrastructure layer indicating relationships between infrastructural components of a given data handling facility 126, a physical layer indicating electrically powered components and their physical connections for the data handling facilities 126, a logical layer indicating logical relationships between different components or systems of the data handling facilities 126. In certain examples, at least some of the facility ontologies 146 are specific to a unique data handling facility 126 while other facility ontologies 146 may correspond to a plurality or group of data handling facilities 126. In certain examples, some of the facility ontologies 146 may correspond to different systems of a selected data handling facility 126. Further, in some examples, facility ontologies 146 map the facility power dataset 144 into topologies that may be selectably interrogated by users of the ontology system 160.

The ontology system 160 of communication system 100 is configured to generate the facility ontologies 146 stored in datastore 140 as well as to manage or interrogate (e.g., at the behest of a user of ontology system 160) the facility ontologies 146 to gain insight to the operation (or proposed future operation) of the network 124. In some examples, the ontology system 160 includes an ontology engine 164. In some examples, ontology system 160 discovers automatically the physical connections (e.g., electrical physical connections) between electrically powered components (e.g., components of power systems, cooling systems, telecommunication hardware) of data handling facilities 126 using only information gleaned or sourced from the facility power dataset 144, and thus does not make use of other sources of information such as engineering drawings that may be incorrect or incomplete. This may be performed by an auto-discovery tool, captured in the facility ontologies 146, and stored in datastore 140.

The ontology engine 164 of ontology system 160 automatically generates and manages the facility ontologies 146 stored in datastore 140 using physical connections of the facilities and the facility power dataset 144. In some examples, the ontology engine 164 is the central management device, as described above.

The facility ontologies 146 generated by ontology engine 164 capture more than the physical connections between electrically powered components of data handling facilities 126. Particularly, ontology engine 164 builds or interleaves additional ontology layers onto the physical ontology. These additional ontology layers pertain to the infrastructure of the data handling facilities 126 (e.g., mapping out the relationship between different floors, rooms, and other infrastructural components of a data handling facility 126 with electrically powered components thereof). Additionally, ontology engine 164 may generate additional ontology layers such as a logical ontology layer defining logical relationships between different components (e.g., infrastructural components, electrically powered components, systems or subsystems) of the data handling facilities 126 which may be leveraged to gain greater insight to the operation of the different data handling facilities 126 of network 124.

In some examples, using the facility power dataset 144, ontology engine 164 may additionally classify in accordance with a predefined taxonomy different electrically powered components of the data handling facilities 126. For example, based on how electrical power flows into and from a given electrically powered component over time, ontology engine 164 may infer a classification for the electrically powered component. The taxonomy may include different classifications of electrically powered components found in power systems, cooling systems, and/or telecommunication hardware of data handling facilities 126. For example, the classifications of the predefined taxonomy may include electrical transformers, electrical switching devices, electrical panels or subpanels, electrical rectifiers, air conditioner compressor motors, air conditioner fan motors, server racks, and the like. For instance, based on a substantial change in electrical voltage across a given electrically powered component of a data handling facility 126, the ontology engine 164 may infer the component is an electrical transformer having capabilities defined by the monitored flow of electrical power into and from the electrical transformer documented in the facility power dataset 144. In this manner, the different electrically powered components of data handling facilities 126 may be classified automatically without needing to rely on other sources of information such as engineering drawings that may be inaccurate, outdated, and/or incomplete.

In an example, the ontology engine 164 performs data validation, as described above. For example, the ontology engine 164 may determine a data integrity for each of the data handling facilities 126 and/or may perform other data validation, such as comparing data of a first data handling facility 126 to that of a second data handling facility 126, execute mitigation actions with respect to a data handling facility 126 or components of a data handling facility 126, or the like.

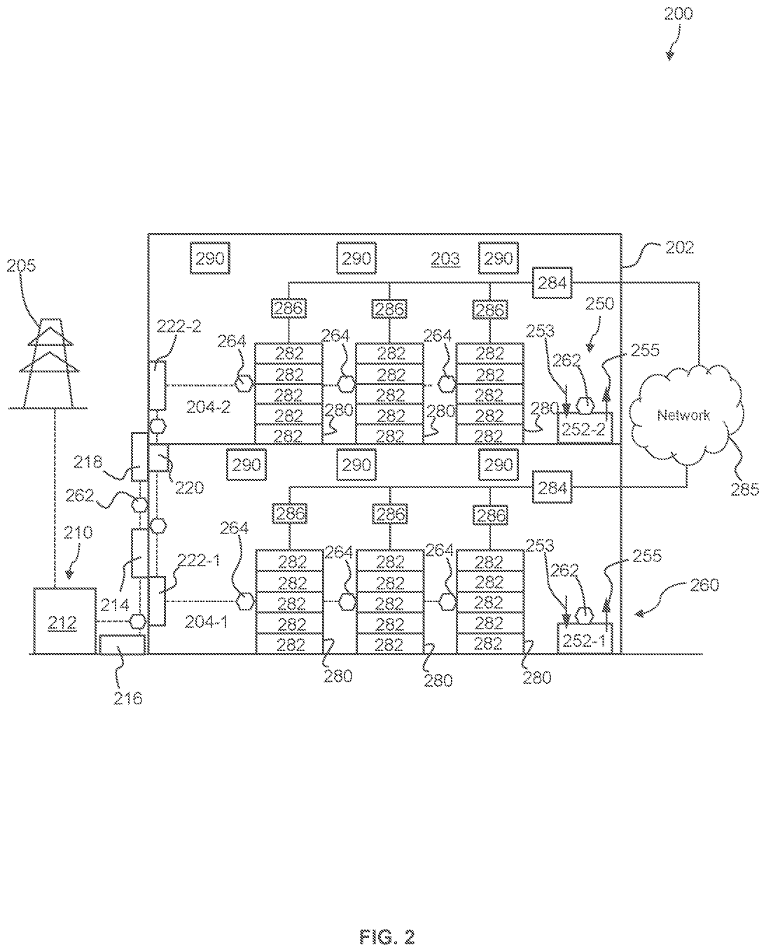

Referring now to FIG. 2, an exemplary data handling facility 200 is illustrated schematically according to some examples. Particularly, data handling facility 200 includes a physical infrastructure 202, a power delivery or simply “power” system 210, a cooling system 250, and a power monitoring system 260. In this example, the physical infrastructure 202 of data handling facility 200 is in the form of a stationary building (and thus infrastructure 202 is also referred to herein as building 202) having a relatively fixed space capacity that is divided between a first floor 204-1 and a second floor 204-2 located vertically above the first floor 204-1. The configuration of physical infrastructure 202 may vary in other examples and thus building 202 serves only as one example of how the physical infrastructure of a given data handling facility may manifest. For example, in other examples, building 202 may comprise a single floor 204 or more than two floors 204. In still other examples, physical infrastructure 202 may not comprise a stationary building having a relatively fixed physical space capacity and instead may comprise a mobile and/or modular infrastructure.

Data handling facility 200 additionally includes telecommunication hardware that is divided between floors 204-1 and 204-2. Particularly, on each floor 204 is positioned a plurality of sever racks 280 each comprising a plurality of network servers 282 (e.g., blade servers). Network servers 282 may be implemented as computer systems. Computer systems are described further herein. In addition, the telecommunication hardware of data handling facility 200 includes one or more routers 284 and one or more network switches 286 connected between the network routers 284 and the server racks 280. Network routers 284 of data handling facility 200 are connected to a network 285 (e.g., network 124 illustrated in FIG. 1). For example, network routers 284 of data handling facility 200 may be connected with the telecommunication hardware of other data handling facilities 200 where a plurality of interconnected data handling facilities 200 at least partially collectively form the backbone or core of the network 285 for directing network traffic therealong.

Network servers 282 of the server racks 280 of data handling facility 200 facilitate various functionalities and features of the network 285. Network servers 282 are connected to the larger network 285 through the network routers 284 of data handling facility 200. Additionally, individual server racks 280 may be selectably isolated from the network 285 via the operation of network switches 286. In some examples, individual network servers 282 of a selected server rack 280 may be isolated from the network 285 via the operation of one or more network switches 286.

In some examples, one or more network servers 282 may comprise application servers hosting one or more server applications (e.g., application servers 130 hosting server applications 132 illustrated in FIG. 1). One or more of network servers 282 may be responsible for properly routing network traffic to ensure users of the network 285 may access desired features hosted on the network 285. Further, one or more network servers 282 may comprise data servers hosting one or more datastores (e.g., datastore 140 illustrated in FIG. 1) of the network 285. Although in this example the telecommunication hardware of data handling facility 200 includes server racks 280, network routers 284, and network switches 286, the composition and/or configuration of the telecommunication hardware may vary in other examples from that shown in FIG. 2. For example, in other examples, the telecommunication hardware of data handling facility 200 may include sensor arrays, data acquisition systems, control architecture, and other computer-implemented hardware.

The telecommunication hardware (e.g., server racks 280, network routers 284, and network switches 286) consume electrical power in order to perform their intended functions, said electrical power being delivered to the telecommunication hardware by the power system 210 of data handling facility 200. In this example, power system 210 of data handing facility 200 generally includes an electrical transformer 212, a switchgear 214, an electrical generator 216, an uninterruptible power supply (UPS) 218, a power distribution unit (PDU) 220, and one or more power supplies 222.

The transformer 212 of power system 210 receives high voltage alternating current (HV-AC) electrical power from an electrical grid 205 connected therewith. Transformer 212 serves to reduce or “step down” the AC voltage of the HV-AC used to transmit the electrical power through the electrical grid 205 (e.g., to minimize transmission losses) to a lesser voltage that may be safely and conveniently handled by the components of power system 210. The stepped down AC voltage electrical power is outputted by the transformer 212 and transferred to the switchgear 214 which, in this example, comprises an AC switchgear. Switchgears such as switchgear 214 comprise electrical switching devices configured to distribute electrical power to a plurality of selectable outputs from a single electrical power input received by the electrical switching device. Electrical switching devices such as switchgears (a high-voltage electrical switching device) typically include electrical busses or busbars, switches, circuit breakers, fuses, and the like.

In addition to transformer 212, electrical generator 216 is also connected to switchgear 214. Particularly, in this example, electrical generator 216 is configured to produce electrical power (e.g., AC electrical power) that is deliverable to the switchgear 214. For example, electrical generator 216 may include an engine powered by a fuel source (e.g., natural gas) for selectably driving the operation of electrical generator 216. Thus, in this example, switchgear 214 may receive electrical power from electrical grid 205 (via the transformer 212) and/or from electrical generator 216. In other examples, power system 210 may not include electrical generator 216 with electrical grid 205 being the only source of electrical power for data handling facility 200. In still other examples, data handling facility 200 may be provisioned with additional sources of electrical power such as a solar array and the like.

Switchgear 214 serves as an electrical switching device for electrically isolating data handling facility 200 from the sources of electrical power (electrical grid 205 and electrical generator 216 in this example) configured to supply data handling facility 200 with electrical power. Thus, by operating switchgear 214, data handling facility 200, including the telecommunication hardware thereof, may be electrically isolated from the electrical grid 205.

The UPS 218 receives electrical power from the switchgear 214 when the switchgear 214 is in a “closed” state electrically connecting the UPS 218 with the transformer 212 and electrical generator 216. UPS 218 is generally configured to provide a reliable, uninterrupted flow of electrical power to the telecommunication hardware (e.g., server racks 280, network routers 284, and network switches 286) of data handling facility 200. Additionally, UPS 218 provides an uninterrupted flow of electrical power to the cooling system 250 of data handling facility 200. In some examples, UPS 218 is configured to store backup electrical power (e.g., via batteries of the UPS 218) for providing the data handling facility 200 with electrical power in the event that the normal sources of electrical power (e.g., electrical grid 205 and/or electrical generator 216) become unavailable so that the distribution of power to the telecommunication hardware and/or cooling system 250 of data handling facility 200 is not interrupted. However, UPS 218 may only store a finite amount of electrical power and thus continued operation of the electrically powered equipment of data handling facility 200 is contingent upon one of the normal sources of electrical power for data handling facility 200 being restored before the backup power supplied by UPS 218 has been consumed.

The PDU 220 of power system 210 distributes electrical power received from the UPS 218 of power system 210 to various electrically powered equipment of data handling facility 200. In this example, PDU 220 distributes AC electrical power to a pair of power supplies 222-1, 222-2, and the cooling system 250 of data handling facility 200. Power supplies 222-1 and 222-2 of power system 210 convert the AC electrical power received thereby from PDU 220 into DC electrical power that is supplied to the telecommunication hardware (e.g., server racks 280, network routers 284, and network switches 286) of data handling facility 200.

In this example, each floor 204-1 and 204-2 of building 202 is provided with its own power supply 222-1 and 222-2, respectively, for powering the telecommunication hardware located on the given floor 204-1 and 204-2. However, the composition and configuration of the components of power system 210 may vary in other examples. For example, in other examples, a single power supply 222 may power the telecommunication hardware for both floors 204-1 and 204-2. In other examples, each server rack 280 may have its own unique power supply 222. In still other examples, power system 210 may not include electrical generator 216 and/or UPS 218.

Further, power system 210 comprises an AC power system in this example such that the AC electrical power received by power system 210 is only converted to DC electrical power at the last instance when the electrical power is supplied to the DC electrically powered equipment of data handling facility 200. However, in other examples, power system 210 may comprise a DC power system including a DC rectifier positioned between the given power source (e.g., electrical grid 205) and the switchgear for converting the AC electrical power received from the power source into DC electrical power upstream of the switchgear. In this configuration, the switchgear would receive DC electrical power from the DC rectifier. At least some of the network switches 286 and network routers 284 may receive DC electrical power.

During operation of data handling facility 200, the telecommunication hardware (e.g., server racks 280, network routers 284, and network switches 286) thereof may consume substantial amounts of electrical power supplied by the power system 210. At least a portion of the electrical power consumed by the telecommunication hardware of data handling facility 200 is converted into thermal energy that radiates from the telecommunication hardware through an interior 203 of the building 202 of data handling facility 200.

Given that the telecommunication hardware of data handling facility 200 may consume substantial amounts of electrical power, the telecommunication hardware may similarly generate substantial amounts of heat during the operation of data handling facility 200. Indeed, the heat generated by the telecommunication hardware may, without adequate cooling, lead to overheating (e.g., operate at a temperature falling outside of an operational temperature range of the hardware) of at least some of the telecommunication hardware such that the hardware may be at risk of incurring damage or otherwise at risk of not performing as intended. Cooling system 250 of data handling facility 200 thus provides cooling to the interior 203 of building 202 sufficient to adequately cool the telecommunication hardware located therein and prevent the telecommunication hardware from overheating.

In this example, cooling system 250 is configured to implement a closed-loop refrigeration cycle in which heat (e.g., heat generated by the server racks 280, network routers 284, and network switches 286 of data handling facility 200) is pumped from the interior 203 of building 202 to the ambient environment surrounding the building 202. Particularly, in this example, cooling system 250 includes a pair of computer room air conditioning (CRAH) units 252-1 and 252-2 divided between the floors 204-1 and 204-2 of building 202. Each CRAH unit 252-1 and 252-2 comprises an evaporator fluidically coupled with a condenser or cooler that is external the building 202. In this configuration, each CRAH unit 252-1/252-2 receives a stream of hot air 253 that is cooled by the evaporator of the CRAH unit 252-1/252-2 and rejected from the CRAH unit 252-1/252-2 as cooled air 255. Particularly, heat from the hot air 253 is transferred to coolant circulating through the evaporator and which may be pumped to a condenser located external the building 202 where the heat is transferred from the condenser to the ambient air of the external environment.

While in this example cooling system 250 is configured to implement a closed-loop, mechanical refrigeration cycle, the configuration of cooling system 250 may vary in other examples. For example, in some examples, cooling system 250 may include one or more computer room air handlers (CRAHs) that do not make use of mechanical refrigeration.

Each CRAH unit 252-1/252-2 may have a corresponding cooling capacity (e.g., measured in kWs) that is contingent on the configuration (e.g., the size of the evaporator, blower, and/or condenser, the volume or type of refrigerant, and other factors) of the respective CRAH unit 252-1/252-2. In addition to a cooling capacity, each CRAH unit 252-1/252-2 may have a corresponding efficiency based on the configuration of the respective CRAH unit 252-1/252-2 that relates the amount of cooling that the CRAH unit 252-1/252-2 provides for a given amount of input power (e.g., AC electrical power measured in kWs) consumed by the CRAH unit 252-1/252-2. For instance, based on the efficiency of a given CRAH unit (or other cooling unit of cooling system 250), an amount of cooling provided by the CRAH unit may be estimated based on the amount of input power consumed by the CRAH unit over a given period of time.

The power monitoring system 260 of data handling facility 200 monitors different parameters of the data handling facility 200, particularly with respect to the flow of power and data signals through the data handling facility 200. In some examples, power monitoring system 260 is communicatively coupled to the network 285 permitting remote monitoring of the data handling facility 200 through the power monitoring system 260. In certain examples, power monitoring system 260 may provide real-time or near real-time monitoring information to a user located either onsite at the data handling facility 200 or located remotely via the network 285.

In this example, power monitoring system 260 includes a plurality of power sensors (e.g., current sensors) for monitoring power consumption (e.g., electrical power consumption in kWs) over time. In this example, power monitoring system 260 includes a plurality of AC power monitors 262 and a plurality of DC power monitors 264. AC power monitors 262 are connected between the different AC-powered components of power system 210 including, for example, transformer 212, switchgear 214, generator 216, UPS 218, PDU 220, and power supplies 222. DC power monitors 264 are linked to specific pieces of telecommunication hardware of data handling facility 200 such that the electrical power consumed by the respective telecommunication hardware may be individually monitored over time.

At least some of the AC power monitors 262 may comprise preexisting equipment installed, e.g., during the original construction of data handling facility 200. Alternatively, at least some of the AC power monitors may be equipment installed specifically for the purpose of enabling the functionality of an ontology system. The AC power monitors 262 monitor one or more parameters pertaining to the AC electrical power flowing through the given AC power monitor 262. For example, AC power monitors 262 may monitor AC current and voltage over time (e.g., associating the monitored AC current and voltage with a timestamp). In some examples, at least some of the AC power monitors 262 may monitor additional parameters including, for example, frequency, phasing, voltage distortion, and the like.

The DC power monitors 264 of power monitoring system 260 are connected between the different DC-powered components of data handling facility 200 including the telecommunication hardware thereof such as, for example, network servers 282, network routers 284, and network switches 286. At least some of the DC power monitors 264 may comprise preexisting equipment installed, e.g., during the original construction of data handling facility 200. Alternatively, at least some of the DC power monitors may be equipment installed specifically for the purpose of enabling the functionality of an ontology system. The DC power monitors 264 monitor one or more parameters pertaining to the DC electrical power flowing through the given DC power monitor 264. For example, DC power monitors 264 may monitor DC current and voltage over time.

AC power monitors 262 permit the monitoring of the flow of AC electrical power through the data handling facility 200. For example, AC power monitors 262 may be positioned to measure or monitor the amount of electrical power flowing into the UPS 218 of power system 210 over time. In this manner, the AC power monitors 262 may monitor the total amount of electrical power consumed by the digital handling facility (e.g., from electrical grid 205 and/or electrical generator 216) over time.

In addition to the above, one or more of the AC power monitors 262 may be positioned to monitor the amount of power consumed by cooling system 260 over time. For example, one or more of the AC power monitors 262 may be individually linked to or correspond with a unique CRAH unit 252-1/252-2. In this manner, a user (locally or remotely) may monitor, using the AC power monitors 262, the amount of electrical power individually consumed by CRAH units 252-1/252-2 over time. The amount of power consumed by CRAH units 252-1/252-2 over time may provide insight into the amount of cooling required for the data handling facility 200 and the ability of cooling system 250 in meeting those requirements over time. For example, the amount of cooling delivered by cooling system 250 over time may be estimated based on the monitored power consumed by CRAH units 252-1/252-2 and the known efficiencies of the CRAH units 252-1/252/2.

In an example, each of the AC power monitors 262 and the DC power monitors 264 may be referred to as nodes herein. In an example, each of the nodes communicates with the network 285, and thereby the ontology system 160 and ontology engine 164, via one or more gateway devices 290. In some examples, the gateway devices 290 are wired components, while in other examples the gateway devices 290 are wireless devices that are communicatively coupled wirelessly with the nodes (e.g., the AC power monitors 262 and the DC power monitors 264). In some examples, the gateway devices 290 form a mesh network which may be self-healing. In this way, in response to one of the gateway devices 290 becoming unresponsive or going offline, the AC power monitors 262 and the DC power monitors 264 previously communicatively coupled with that offline gateway device 290 may instead seek out and communicatively couple to another gateway device 290, reestablishing network connectivity.

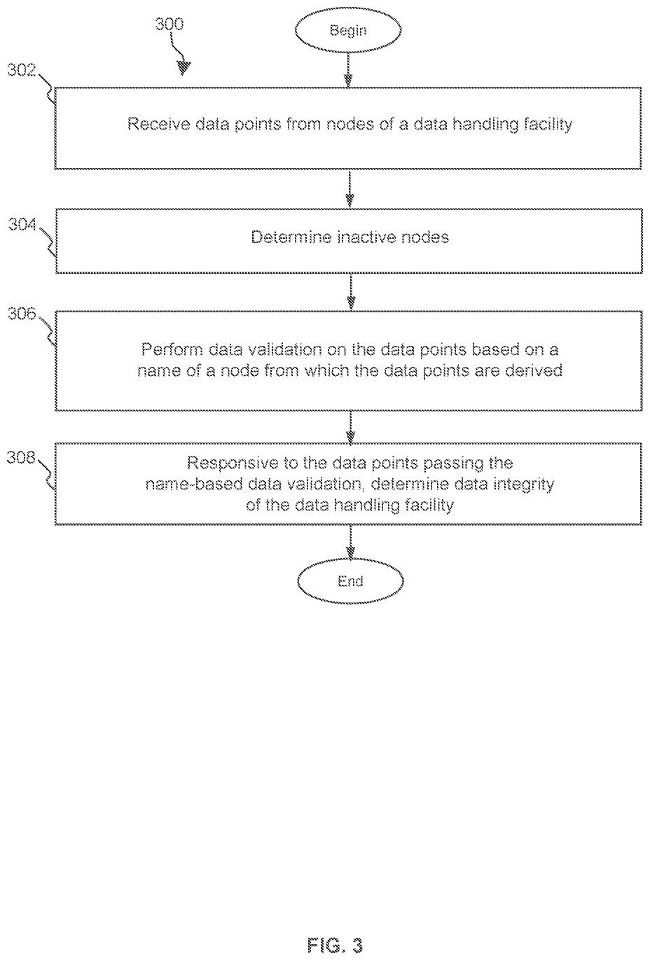

Turning to FIG. 3, a method 300 is described, in accordance with various examples. In an example, the method 300 is a method for data validation of an ontology of a data handling facility (e.g., data handling facilities 126 illustrated in FIG. 1 and/or data handling facility 200 illustrated in FIG. 2) of a communication system (e.g., communication system 100 illustrated in FIG. 1), such as may be performed by an ontology engine. Method 300 may also be said to comprise a method of operating and/or maintaining a data handling facility and/or a communication system.

At operation 302, data points are received from nodes of a data handling facility. In some examples, the nodes are sensors, such as AC or DC voltage sensors. In other examples, the nodes are temperatures sensors. In other examples, the sensors provide any other suitable information, such as may be useful in forming an ontology of the data handling facility. In some examples, the data points are measurements. For example, the measurements may be power measurements indicating an amount of AC power (or current) flowing into or out of a device or an amount of DC power (or current) flowing into or out of a device. In other examples, the measurements are temperature measurements. In other examples, the measurements are flow measurements of a coolant.

At operation 304, inactive nodes are determined. In some examples, inactive nodes are nodes from which data points have not been received in a specified amount of time. In some examples, the specified amount of time is about 24 hours. In other examples, the specified amount of time is any suitable period of time, such as about 1 hour, about 2 hours, about 6 hours, about 12 ours, about 48 hours, or the like.

At operation 306, data validation is performed on the data points based on a name of a node from which the data points are derived. For example, valid data points may have a name that follows a prescribed naming convention or format. In some examples, the naming format includes an identifier for a facility in which the node is located, such as a CLLI, a device category for the node (e.g., relay rack, power distribution unit, gateway, etc.), a room number identity for a room in which the node is located, a row number identity for a row of racks in which the node is located, a position within the row identity at which the node is located, and a device in the rack (e.g., a current transducer on the A feed and the 2^{nd} feed of the A feed lines). In some examples, responsive to the name of the node failing the data validation, data points resulting from that node may be rejected and deleted. In other examples, responsive to the name of the node failing the data validation, data points resulting from that node may be flagged for user review and/or correction. Responsive to the name of the node passing the data validation, the data points resulting from that node may be stored, such as in the facility power datasets 144, as described above.

At operation 308, responsive to the data points passing the name-based data validation, data integrity of the data handling facility is determined. For example, for a specified amount of time (e.g., 24 hours), a specified number of data points may be expected from a data handling facility. For example, for a data facility having 240 nodes or sensors, which each provide data points every 15 minutes, 23,040 data points may be expected in a 24 hour period (e.g., 4 data points per node per hour, for 24 hours, for 240 nodes). However, for various reasons, fewer than 23,040 data points may be received. Thus, the data integrity may be a ratio of the number of received data points to the expected number of data points. In some examples, an acceptable data integrity threshold may be defined, such as about 0.90 or 90%, 0.95 or 95%, or the like. Responsive to the determined data integrity being less than the acceptable data integrity threshold, in some examples, the ontology engine takes remedial action. In some examples, the remedial action includes directing a technician to perform an action. In other examples, the remedial action is performed automatically and without human intervention, such as power cycling a node, resetting a network connection of a node, requesting a node, network element, or other device to report its status, power cycling a network device for which a node is monitoring power or some other operational characteristic, or the like.

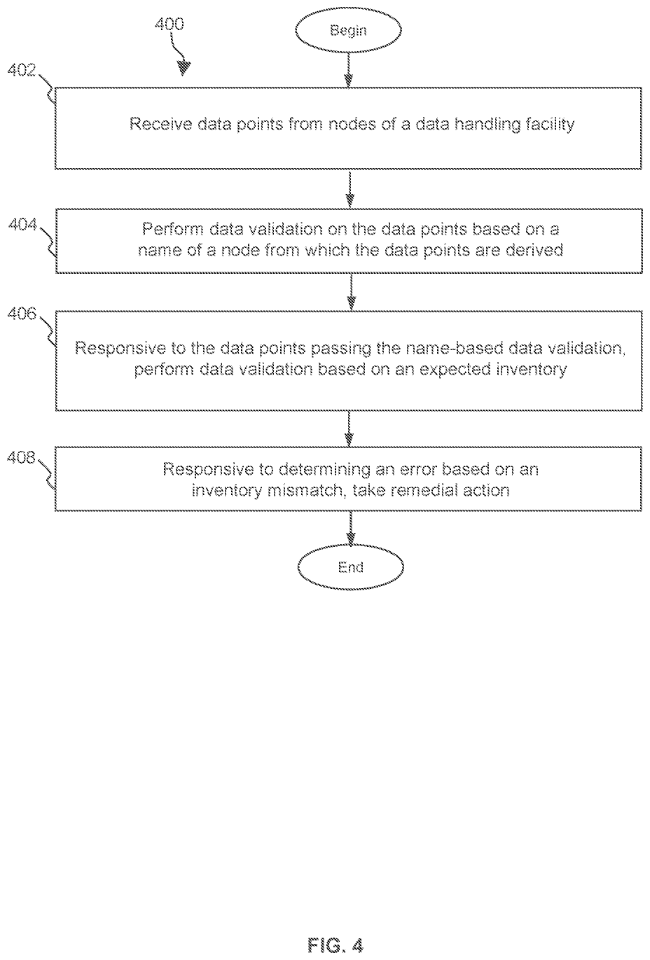

Turning to FIG. 4, a method 400 is described, in accordance with various examples. In an example, the method 400 is a method for data validation of an ontology of a data handling facility (e.g., data handling facilities 126 illustrated in FIG. 1 and/or data handling facility 200 illustrated in FIG. 2) of a communication system (e.g., communication system 100 illustrated in FIG. 1), such as may be performed by an ontology engine. Method 400 may also be said to comprise a method of operating and/or maintaining a data handling facility and/or a communication system.

At operation 402, data points are received from nodes of a data handling facility. In some examples, the nodes are sensors, such as AC or DC voltage sensors. In other examples, the nodes are temperatures sensors. In other examples, the sensors provide any other suitable information, such as may be useful in forming an ontology of the data handling facility. In some examples, the data points are measurements. For example, the measurements may be power measurements indicating an amount of AC power (or current) flowing into or out of a device or an amount of DC power (or current) flowing into or out of a device. In other examples, the measurements are temperature measurements. In other examples, the measurements are flow measurements of a coolant.

At operation 404, data validation is performed on the data points based on a name of a node from which the data points are derived. For example, valid data points may have a name that follows a prescribed naming convention or format. In some examples, the naming format includes an identifier for a facility in which the node is located, such as a CLLI, a device category for the node (e.g., relay rack, power distribution unit, gateway, etc.), a room number identity for a room in which the node is located, a row number identity for a row of racks in which the node is located, a position within the row identity at which the node is located, and a device in the rack (e.g., a current transducer on the A feed and the 2^{nd} feed of the A feed lines). In some examples, responsive to the name of the node failing the data validation, data points resulting from that node may be rejected and deleted. In other examples, responsive to the name of the node failing the data validation, data points resulting from that node may be flagged for user review and/or correction. Responsive to the name of the node passing the data validation, the data points resulting from that node may be stored, such as in the facility power datasets 144, as described above.

At operation 406, responsive to the data points passing the name-based data validation, data validation based on an expected inventory is performed. For example, for a given data handling facility, an inventory or asset management system may specify an expected inventory for the data handling facility. In some examples, the ontology engine may cross-reference the inventory management system to compare an expected data handling facility inventory to a reported data handling facility inventory. For example, the inventory management system may indicate that the data handling facility has 480 nodes and 7 gateways. However, the data points received by the ontology engine may indicate that the data handling facility includes fewer or a greater number of nodes and/or gateways. For example, responsive to a data reporting error or hardware error related to the nodes, or an inventory error.

At operation 408, responsive to determining an error based on an inventory mismatch, the ontology engine takes remedial action. In some examples, the remedial action includes directing a technician to perform an action. In other examples, the remedial action is performed automatically and without human intervention, such as power cycling a node, resetting a network connection of a node, requesting a node, network element, or other device to report its status, power cycling a network device for which a node is monitoring power or some other operational characteristic, or the like.

Turning now to FIG. 5A, an exemplary communication system 650 is described. Typically, the communication system 650 includes a number of access nodes 654 that are configured to provide coverage in which UEs 652 such as cell phones, tablet computers, machine-type-communication devices, tracking devices, embedded wireless modules, and/or other wirelessly equipped communication devices (whether or not user operated), can operate. The access nodes 654 may be said to establish an access network 656. The access network 656 may be referred to as a radio access network (RAN) in some contexts.

In a 5G technology generation an access node 654 may be referred to as a next Generation Node B (gNB). In 4G technology (e.g., long term evolution (LTE) technology) an access node 654 may be referred to as an evolved Node B (eNB). In 3G technology (e.g., code division multiple access (CDMA) and global system for mobile communication (GSM)) an access node 654 may be referred to as a base transceiver station (BTS) combined with a base station controller (BSC). In some contexts, the access node 654 may be referred to as a cell site or a cell tower. In some implementations, a picocell may provide some of the functionality of an access node 654, albeit with a constrained coverage area. Each of these different examples of an access node 654 may be considered to provide roughly similar functions in the different technology generations.

In an example, the access network 656 comprises a first access node 654a, a second access node 654b, and a third access node 654c. The access network 656 may include any number of access nodes 654. Further, each access node 654 could be coupled with a core network 658 that provides connectivity with various application servers 659 and/or a network 660. In an example, at least some of the application servers 659 may be located close to the network edge (e.g., geographically close to the UE 652 and the end user) to deliver so-called “edge computing.” The network 660 may be one or more private networks, one or more public networks, or a combination thereof. The network 660 may comprise the public switched telephone network (PSTN). The network 660 may comprise the Internet. With this arrangement, a UE 652 within coverage of the access network 656 could engage in air-interface communication with an access node 654 and could thereby communicate via the access node 654 with various application servers and other entities.

The communication system 650 could operate in accordance with a particular radio access technology (RAT), with communications from an access node 654 to UEs 652 defining a downlink or forward link and communications from the UEs 652 to the access node 654 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 654 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 654 could define an air interface configured in a specific manner to define physical resources for carrying information wirelessly between the access node 654 and UEs 652.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 652.

In addition, certain resource elements on the example air interface could be reserved for special purposes. For instance, on the downlink, certain resource elements could be reserved to carry synchronization signals that UEs 652 could detect as an indication of the presence of coverage and to establish frame timing, other resource elements could be reserved to carry a reference signal that UEs 652 could measure in order to determine coverage strength, and still other resource elements could be reserved to carry other control signaling such as PRB-scheduling directives and acknowledgement messaging from the access node 654 to served UEs 652. And on the uplink, certain resource elements could be reserved to carry random access signaling from UEs 652 to the access node 654, and other resource elements could be reserved to carry other control signaling such as PRB-scheduling requests and acknowledgement signaling from UEs 652 to the access node 654.

The access node 654, in some instances, may be split functionally into a radio unit (RU), a distributed unit (DU), and a central unit (CU) where each of the RU, DU, and CU have distinctive roles to play in the access network 656. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 5B, further details of the core network 658 are described. In an example, the core network 658 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 679, an authentication server function (AUSF) 675, an access and mobility management function (AMF) 676, a SMF 677, a network exposure function (NEF) 670, a network repository function (NRF) 671, a policy control function (PCF) 672, a UDM 673, a network slice selection function (NSSF) 674, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 658 may be segregated into a user plane 680 and a control plane 682, thereby promoting independent scalability, evolution, and flexible deployment.

The UPF 679 delivers packet processing and links the UE 652, via the access network 656, to a data network 690 (e.g., the network 660 illustrated in FIG. 5A). The AMF 676 handles registration and connection management of non-access stratum (NAS) signaling with the UE 652. Said in other words, the AMF 676 manages UE registration and mobility issues. The AMF 676 manages reachability of the UEs 652 as well as various security issues. The SMF 677 handles session management issues. Specifically, the SMF 677 creates, updates, and removes (destroys) PDU sessions and manages the session context within the UPF 679. The SMF 677 decouples other control plane functions from user plane functions by performing dynamic host configuration protocol (DHCP) functions and IP address management functions. The AUSF 675 facilitates security processes.

The NEF 670 securely exposes the services and capabilities provided by network functions. The NRF 671 supports service registration by network functions and discovery of network functions by other network functions. The PCF 672 supports policy control decisions and flow based charging control. The UDM 673 manages network user data and can be paired with a user data repository (UDR) that stores user data such as customer profile information, customer authentication number, and encryption keys for the information. An application function 692, which may be located outside of the core network 658, exposes the application layer for interacting with the core network 658. In an example, the application function 692 may be execute on an application server 659 located geographically proximate to the UE 652 in an “edge computing” deployment mode. The core network 658 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 674 can help the AMF 676 to select the network slice instance (NSI) for use with the UE 652.

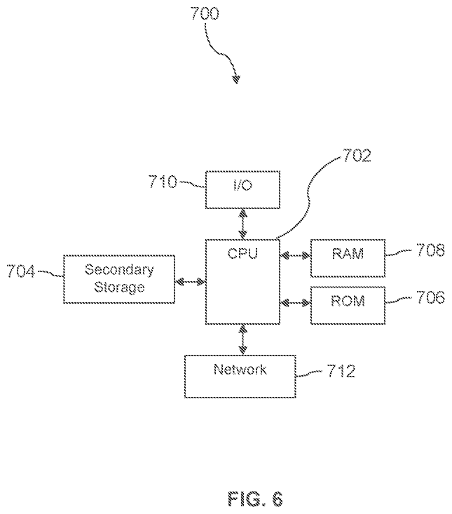

FIG. 6 illustrates a computer system 700 suitable for implementing one or more examples disclosed herein. The computer system 700 includes a processor 702 (which may be referred to as a central processor unit or CPU) that is in communication with memory devices including secondary storage 704, read only memory (ROM) 706, random access memory (RAM) 708, input/output (I/O) devices 510, and network connectivity devices 712. The processor 702 may be implemented as one or more CPU chips.

By programming and/or loading executable instructions onto the computer system 700, at least one of the CPU 702, the RAM 708, and the ROM 706 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 702 may execute a computer program or application. For example, the CPU 702 may execute software or firmware stored in the ROM 706 or stored in the RAM 708. In some cases, on boot and/or when the application is initiated, the CPU 702 may copy the application or portions of the application from the secondary storage 704 to the RAM 708 or to memory space within the CPU 702 itself, and the CPU 702 may then execute instructions that the application is comprised of. In some cases, the CPU 702 may copy the application or portions of the application from memory accessed via the network connectivity devices 712 or via the I/O devices 710 to the RAM 708 or to memory space within the CPU 702, and the CPU 702 may then execute instructions that the application is comprised of. During execution, an application may load instructions into the CPU 702, for example load some of the instructions of the application into a cache of the CPU 702. In some contexts, an application that is executed may be said to configure the CPU 702 to do something, e.g., to configure the CPU 702 to perform the function or functions promoted by the subject application. When the CPU 702 is configured in this way by the application, the CPU 702 becomes a specific purpose computer or a specific purpose machine.

The secondary storage 704 is typically comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The RAM 708 is used to store volatile data and perhaps to store instructions. Access to both ROM 706 and RAM 708 is typically faster than to secondary storage 704. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 712 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 712 may provide wired communication links and/or wireless communication links (e.g., a first network connectivity device 712 may provide a wired communication link and a second network connectivity device 712 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an example, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 712 may enable the processor 702 to communicate with the Internet or one or more intranets. With such a network connection, it is contemplated that the processor 702 might receive information from the network, or might output information to the network in the course of performing the above-described method steps. Such information, which is often represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 702 executes instructions, codes, computer programs, scripts which it accesses from hard disk, floppy disk, optical disk (these various disk-based systems may all be considered secondary storage 704), flash drive, ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an example, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a dataset by the two or more computers. In an example, virtualization software may be employed by the computer system 700 to provide the functionality of a number of servers that is not directly bound to the number of computers in the computer system 700. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an example, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 704, to the ROM 706, to the RAM 708, and/or to other non-volatile memory and volatile memory of the computer system 700. The processor 702 may process the executable instructions and/or data structures in part by directly accessing the computer program product, for example by reading from a CD-ROM disk inserted into a disk drive peripheral of the computer system 700. Alternatively, the processor 702 may process the executable instructions and/or data structures by remotely accessing the computer program product, for example by downloading the executable instructions and/or data structures from a remote server through the network connectivity devices 712. The computer program product may comprise instructions that promote the loading and/or copying of data, data structures, files, and/or executable instructions to the secondary storage 704, to the ROM 706, to the RAM 708, and/or to other non-volatile memory and volatile memory of the computer system 700.

In some contexts, the secondary storage 704, the ROM 706, and the RAM 708 may be referred to as a non-transitory computer readable medium or a computer readable storage media. A dynamic RAM example of the RAM 708, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 702 may comprise an internal RAM, an internal ROM, a cache memory, and/or other internal non-transitory storage blocks, sections, or components that may be referred to in some contexts as non-transitory computer readable media or computer readable storage media.

While several examples have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various examples as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for managing an ontology of a data handling facility of a communication system, the method comprising:
receiving data points from a node of the data handling facility, the data points indicating the node as a reporting node;
performing name-based data validation of the data points;
responsive to the data points passing the name-based data validation, recording the data points in a data store;
determining a performance metric based on the data points;
comparing the performance metric to an expected metric; and
responsive to the performance metric having a difference from the expected metric that exceeds a standard deviation, performing remedial actions regarding the data handling facility.

2. The method of claim 1, wherein the performance metric is an amount of current flowing into a unit of the data handling facility from a distribution device, the expected metric is an amount of current flowing into the distribution device, and the remedial action is power cycling a device of the data handling facility.

3. The method of claim 2, wherein the unit of the data handling facility is a number of network equipment racks, and the device of the data handling facility is at least one sensor included in the network equipment racks.

4. The method of claim 1, wherein the remedial action includes transmitting an instruction to the node to cause the node to provide a current status of the node.

5. The method of claim 1, wherein the node has a standardized naming format, the node name including an identifier of the data handling facility, a device category of the node, an identifier of a room in which the node is located within the data handling facility, an identifier of a row of network equipment racks in which the node is located within the room, a position of the node within the row, and an identifier of a device within the network equipment rack.

6. The method of claim 1, further comprising performing a regular expression check of the node name to perform the name-based data validation.

7. A method for managing an ontology of a data handling facility of a communication system, the method comprising:
receiving data points from a node of the data handling facility, the data points indicating the node as a reporting node;
performing name-based data validation of the data points;
responsive to the data points passing the name-based data validation, recording the data points in a data store; and
determining data integrity of the data handling facility by determining a ratio of recorded data points over a specified period of time to a number of expected data points over the specified period of time.

8. The method of claim 7, further comprising, responsive to the data points failing the name-based data validation, deleting the data points.

9. The method of claim 7, further comprising, responsive to the data integrity having a value less than a threshold value, performing remedial actions regarding the data handling facility.

10. The method of claim 9, wherein the remedial action includes interrogating a device of the data handling facility to determine a status of the device.

11. The method of claim 9, wherein the remedial action includes power cycling a device of the data handling facility.

12. The method of claim 7, further comprising determining that a second node has an inactive status responsive to not receiving any data points from the node in a 24-hour period of time.

13. The method of claim 7, wherein the node has a standardized naming format, the node name including an identifier of the data handling facility, a device category of the node, an identifier of a room in which the node is located within the data handling facility, an identifier of a row of network equipment racks in which the node is located within the room, a position of the node within the row, and an identifier of a device within the network equipment rack.

14. The method of claim 13, further comprising performing a regular expression check of the node name to perform the name-based data validation.

15. A method for managing an ontology of a data handling facility of a communication system, the method comprising:
receiving data points from a node of the data handling facility, the data points indicating the node as a reporting node;
performing name-based data validation of the data points;
responsive to the data points passing the name-based data validation, recording the data points in a data store; and
cross-referencing an inventory management system to perform an inventory-based data validation of the data points.

16. The method of claim 15, wherein performing the inventory-based data validation of the data points includes:
determining, based on the inventory management system, an expected inventory of the data handling facility;
determining, based on the data store, a reported inventory of the data handling facility based on nodes of the data handling facility for which data points have been received;
comparing the expected inventory to the reported inventory; and
responsive to a mismatch between the expected inventory and the reported inventory, performing remedial actions regarding the data handling facility.

17. The method of claim 16, wherein the remedial actions include interrogating a device of the data handling facility to determine a status of the device.

18. The method of claim 16, wherein the remedial actions include power cycling a device of the data handling facility.

19. The method of claim 15, wherein the node has a standardized naming format, the node name including an identifier of the data handling facility, a device category of the node, an identifier of a room in which the node is located within the data handling facility, an identifier of a row of network equipment racks in which the node is located within the room, a position of the node within the row, and an identifier of a device within the network equipment rack.

20. The method of claim 15, further comprising performing a regular expression check of the node name to perform the name-based data validation.
